(19) United States
(12) Patent Application Publication
(10) Pub. No.: US 2009/0257704 A1
(43) Pub. Date: Oct. 15, 2009

(54) GAS DETECTION APPARATUS USING OPTICAL WAVEGUIDE

(75) Inventor: Shinya YAMAGUCHI, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: MITSUMI ELECTRIC CO, LTD., Tokyo (JP)

(21) Appl. No.: 12/400,482

(22) Filed: Mar. 9, 2009

(30) Foreign Application Priority Data
Apr. 9, 2008 (JP) 2008-100919

(51) Int. Cl. G02B 6/00

(52) U.S. Cl. 385/12

(57) ABSTRACT

Provided is a gas detection apparatus comprising an optical waveguide, wherein the optical waveguide comprises: a core formed on a substrate, the core having a refraction index of n1; and a clad to cover an upper part of the core, the clad having a refraction index of n2, wherein at least one side of a cross-sectional surface of the core, perpendicular to a light propagation direction, is formed by a straight line, and wherein the clad is formed from a sensitive resin which makes a magnitude relation of the refraction index of the core and the refraction index of the clad satisfy n1≦n2 in an atmosphere where a density of a detection gas is less than a predetermined density, and which makes the magnitude relation satisfy n1>n2 in an atmosphere where the density of the detection gas is not less than the predetermined density.

### BACKGROUND OF THE INVENTION

1. Field of the Invention

The present invention relates to a gas detection apparatus using an optical waveguide.

2. Description of Related Art

Conventionally, as a sensor to detect a specific gas, a sensor to which an optical plastic fiber is applied is known (see, for example, Japanese Patent Application Laid Open Publication No. 11-44640).

This optical fiber sensor comprises a core in which a refraction index is n_{CO}, and a clad in which a refraction index is n_{CL}. This optical fiber sensor applies the principle in which the magnitude relation of the refraction index n_{CO} and the refraction index n_{CL} reverses by the existence and non-existence of detection gas of a predetermined density. To put it more concretely, first, by a reaction of a sensitive resin which forms the clad with the detection gas, the refraction index n_{CL} is changed from a value which is larger than the refraction index n_{CO} of the core to a value which is smaller than the refraction index n_{CO}. Subsequently, by the change of the refraction index n_{CL}, light is prevented from leaking from the clad, and the response output from the output terminal increases, thereby the detection of the detection gas becomes possible.

However, in the sensor disclosed in Japanese Patent Application Laid Open Publication No. 11-44640, the diameter of the core is at least approximately 100 μm due to the usage of an optical plastic fiber. Thus, it has been difficult to ensure both of the response output and the response speed which decrease according to the increase of the core diameter, at a predetermined level. Specifically, in response to the existence and non-existence of the detection gas with low density, because the change amount of refraction index of the sensitive resin is small, and as a result, only small amount of response output can be obtained, and the response speed was slow.

### SUMMARY OF THE INVENTION

The present invention was made in view of the above described circumstances, and it is therefore, a main object of the present invention is to provide a gas detection apparatus using an optical waveguide, in which a large amount of response output and a high response speed can be obtained even when responding to detection gas with low density.

According to an aspect of the present invention, there is provided a gas detection apparatus comprising an optical waveguide, wherein

the optical waveguide comprises:
a core formed on a substrate, the core having a refraction index of n1; and
a clad to cover an upper part of the core, the clad having a refraction index of n2, wherein

at least one side of a cross-sectional surface of the core, perpendicular to a light propagation direction, is formed by a straight line, and wherein

the clad is formed from a sensitive resin which makes a magnitude relation of the refraction index of the core and the refraction index of the clad satisfy n1≦n2 in an atmosphere where a density of a detection gas is less than a predetermined density, and which makes the magnitude relation satisfy n1>n2 in an atmosphere where the density of the detection gas is not less than the predetermined density.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a perspective view of a gas detection apparatus according to an embodiment;

FIG. 2 is a sectional view which is perpendicular to a light propagation direction of an optical waveguide section which is configured as a slab waveguide type;

FIG. 3 is a sectional view which is perpendicular to the light propagation direction of an optical waveguide section which is configured as a ridge waveguide type;

FIG. 4 is a diagram showing an analysis result of a response output change with respect to a core thickness in the optical waveguide section of the slab waveguide type;

FIG. 5 is a diagram showing an experimental result of a response output change with respect to a refraction index difference in the optical waveguide section of the ridge waveguide type;

FIG. 6 is a view showing an optical waveguide section in a modification example;

FIG. 7 is a view showing one example of the optical waveguide section in the modification example;

FIG. 8 is a view showing another example of the optical waveguide section in the modification example; and

FIG. 9 is a view showing a gas detection apparatus according to a second modification.

### DETAILED DESCRIPTION OF THE PREFERRED EMBODIMENTS

In the following, an embodiment of the present invention will be explained with reference to the drawings.

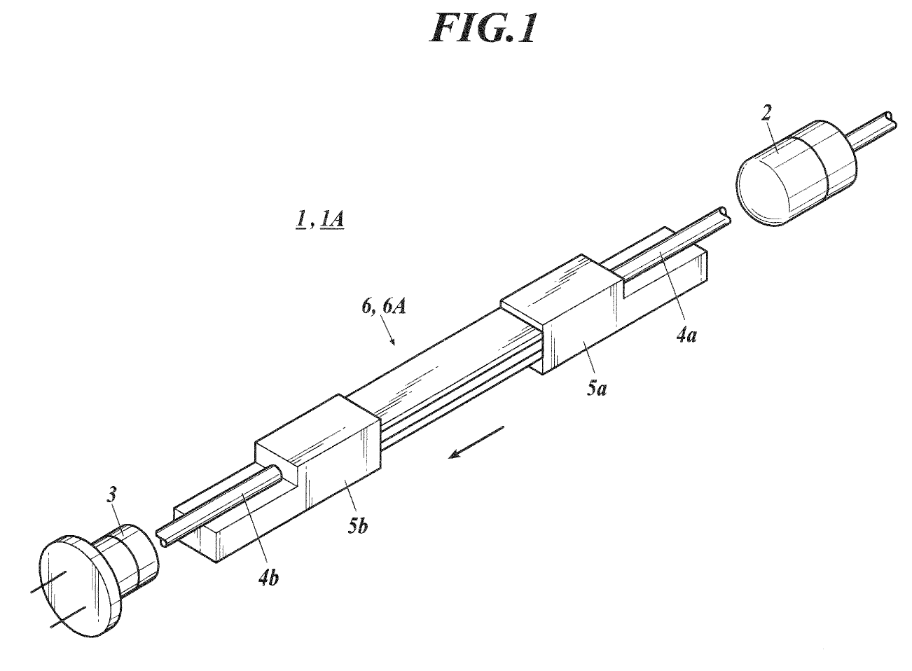

FIG. 1 is a perspective view of a gas detection apparatus using an optical waveguide according to the embodiment of the present invention (hereinafter referred to as a gas detection apparatus 1).

As shown in FIG. 1, the gas detection apparatus 1 comprises a light source 2, a light receiving element 3, a light emitting side and a light receiving side optical fibers 4a, 4b, a light emitting side and a light receiving side optical fiber arrays 5a, 5b, and an optical waveguide section 6. The gas detection apparatus 1 is designed so that the light emitted from the light source 2 is received by the light receiving element 3 as a response output through the optical waveguide section 6 which is exposed to detection gas with a predetermined density, and thus the detection gas can be detected. Here, the detection gas is rot particularly limited, but for example, alcohol and the like.

The light emitting side optical fiber 4a and the light receiving side optical fiber 4b connect the light source 2 and the light receiving element 3 to both edge surfaces of a core 8 of the optical waveguide section 6 which will be described later, respectively so that the light is propagated to the direction shown as an arrow in FIG. 1.

The light emitting side optical fiber array 5a and the light receiving side optical fiber array 5b support the light emitting side optical fiber 4a and the light receiving side optical fiber 4b, respectively, so as to fix the light emitting side optical fiber 4a and the light receiving side optical fiber 4b to the optical waveguide section 6.

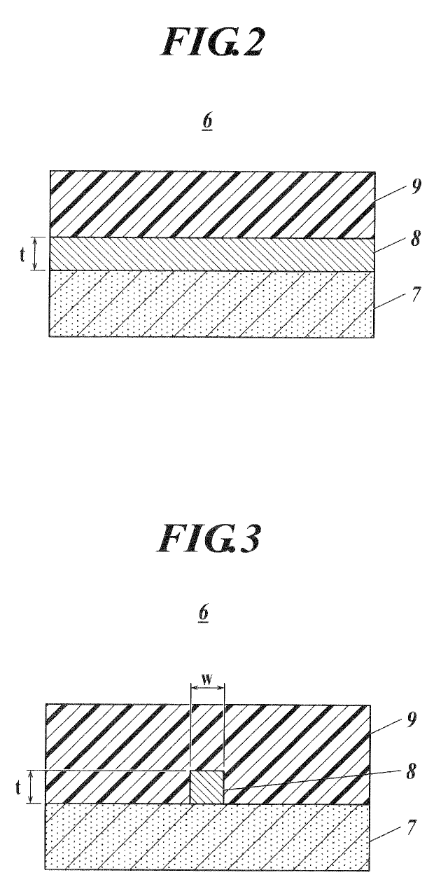

The optical waveguide section 6 is a section to sense the detection gas, and as shown in FIG. 2, the optical waveguide section 6 comprises a substrate 7 which is formed from silicon, a core 8 in which a refraction index is n1, which is formed on the substrate 7, and a clad 9 in which a refraction index is n2, which covers an upper part of the core 8. Here, FIG. 2 is a sectional view which is perpendicular to the light propagation direction of the optical waveguide section 6 which is configured as a slab waveguide type. These substrate 7, core 8, and clad 9 are respectively formed in a rectangular plate having the same length and the same width, so as to be laminated in a state where the length and the width are matched to each other.

The core 8 is formed in a predetermined thickness t, and the thickness t is preferably not more than 20 μm, and even more preferably, riot more than 5 μm. Further, the core 8 is riot particularly limited, but is formed by, for example, acrylic, fluorinated polyimide, or cycloolefin polymer.

The clad 9 is formed from a sensitive resin so that a magnitude relation is n1≦n2 in an atmosphere where the density of the detection gas is less than a predetermined density, and the magnitude relation is n1>n2 in an atmosphere where the density of the detection gas is not less than the predetermined density. There is for example, a novolac resin, as this type of sensitive resin.

Further, as shown in FIG. 3, the optical waveguide section 6 may be configured to be a ridge waveguide type. Here, FIG. 3 is a sectional view which is perpendicular to the light propagation direction of the optical waveguide section 6 which is configured as the ridge waveguide type. In this case, the core 8 is formed to have a width narrower than that of the substrate 7 and the clad 9, and to be covered with the clad 9 except the lower surface of the core 8. Here, as to the thickness t and the width w of the core 8, at least one of them is preferably not more than 20 μm, and it is even more preferable to make it not more than 5 μm. In this regard, the sectional shape of the core 8 is not limited to the substantially square shape as shown, but may be of any shape as long as at least one of the sides is formed by a straight line. In this case, the cross-sectional shape of the core 8 may for example be a rectangular shape or a semicircle shape.

The optical waveguide section 6 can be shaped by a generally known method, such as a method using a dry etching, or a method using a pattern exposure and development. The optical waveguide section 6 shaped in this manner can be reduced in size of the cross-sectional surface of the core 8, unlike the optical plastic fiber which has conventionally been applied to the sensors.

Next, the operation of the gas detection apparatus 1 is explained.

When the gas detection apparatus 1 is placed in an atmosphere in which the density of the detection gas is less than the predetermined density, the magnitude relation is to be (the refraction index of the core) n1≦(the refraction index of the clad) n2. Thus, the light emitted from the light source 2 leaks from the clad 9, and the light receiving amount at the light receiving element 3, that is to say the response output, decreases.

On the other hand, when the gas detection apparatus 1 is placed in an atmosphere in which the density of the detection gas is not less than the predetermined density, the magnitude relation is changed to (the refraction index of the core) n1>(the refraction index of the clad) n2, by the reaction of the clad 9 which is formed from the sensitive resin Thus, the degree of reflectance in the boundary surface of the core 8 and the clad 9 increases. As a result, the light receiving amount at the light receiving element 3, that is to say the response output, increases compared to that in the case where the density of the detection gas is less than the predetermined density.

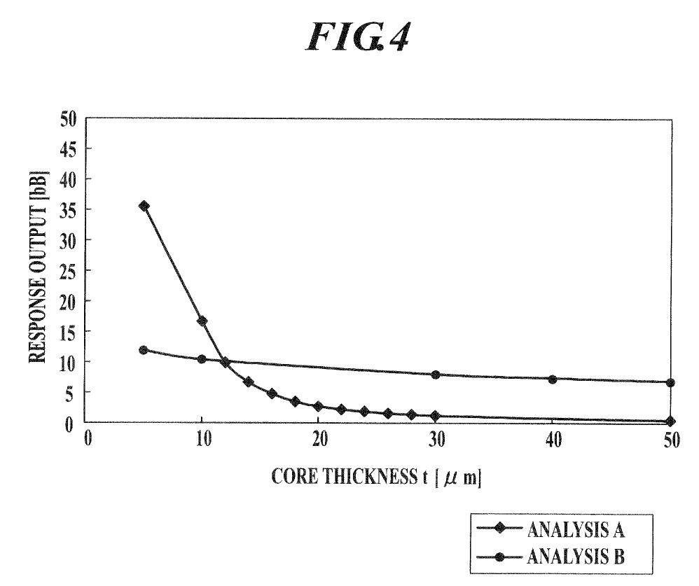

On this occasion, as shown in FIG. 4, the thickness t of the cross-sectional size of the core 8 is greatly influenced by the obtained response output. Here, FIG. 4 is a diagram showing an analysis result of the response output change with respect to the core thickness t in the optical waveguide section 6 of the slab waveguide type. In FIG. 4, the analysis A shows the results by the finite difference beam propagation method, and the analysis B shows the results by the ray tracing method, respectively, which are both performed under the following conditions.

core layer refraction index: 1.532

upper clad layer (clad) film thickness: 1 μm

upper clad layer (clad) refraction index: 1.518-1.552

lower clad layer (substrate) film thickness: 500 μm

lower clad layer (substrate) refraction index: 1.471

length of element: 10 μm

wavelength: 0.64 μm

In FIG. 4, as specifically shown in the results of analysis A, the increase tendency of the response output becomes higher when the core thickness t is not more than 20 μm, and when the core thickness t is 5 μm, a remarkably large amount of the response output can be obtained. Incidentally, although there are not plots indicating the cases in which the core thickness t=not more than 5 μm in FIG. 4, it can be presumed that the response output increases even more when the core thickness t=not more than 5 μm, from the tendency of the chart.

Accordingly, in the optical waveguide section 6 of the slab waveguide type, a large amount of response output can be obtained by making the core thickness t of the core 8 be not more than 20 μm, and even larger amount of response output can be obtained by making it not more than 5 μm.

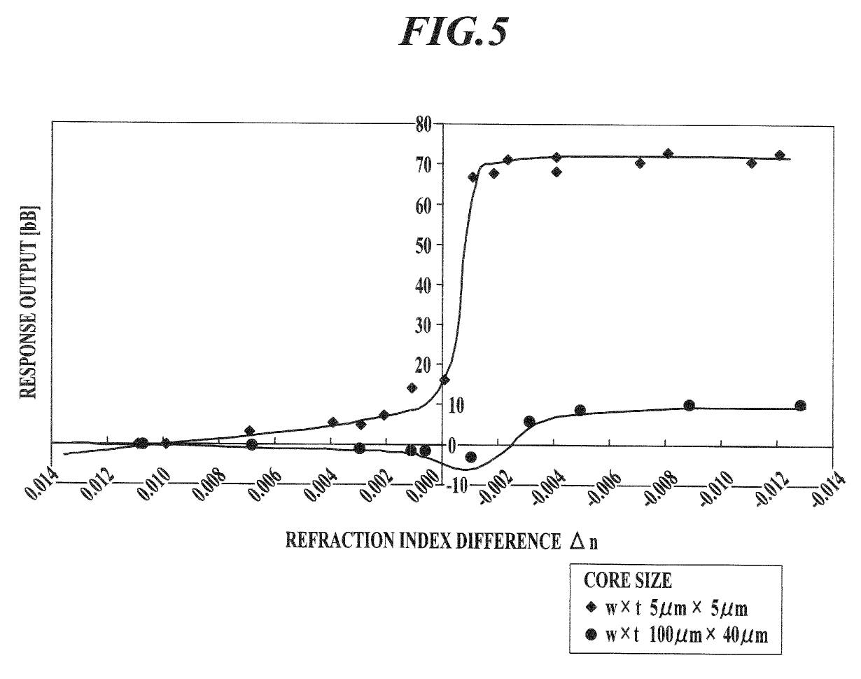

Further, as shown in FIG. 5, the cross-sectional size of the core greatly influences the response output also in a case where the optical waveguide section 6 is a ridge waveguide type. Here, FIG. 5 is a diagram showing experimental results of the response output change with respect to the refraction index difference Δn (=the refraction index n2 of the clad 9−the refraction index n1 of the core 8) in the optical waveguide section 6 of the ridge waveguide type.

This experiment is performed by measuring the response output of the optical waveguide which does not comprise a clad, in a state where the refraction index of the sensitive resin having an oil-like texture to be applied to the core is changed in a range of 1.520-1.545. The experiment is performed by respectively measuring the optical waveguide having a core with a cross-sectional size of width w×thickness t=5 μm×5 μm, and the optical waveguide having a core with a cross-sectional size of 100 μm×40 μm. Further, the experimental condition on this occasion is the same as the one in the analyses shown in FIG. 4.

As shown in FIG. 5, under the condition where the cross-sectional size of the core 8 is width w×thickness t=5 μm×5 μm, the response output drastically changes so as to be a larger amount when the refraction index difference Δn changes to a minus, that is to say, when the light stops leaking from the clad 9.

Accordingly, in the optical waveguide section 6 of the ridge waveguide type, a larger amount of response output and faster response speed can be obtained by decreasing the width w×the thickness t of the core 8. Further, as long as the refraction index difference Δn is a minus, these response output and response speed can be obtained even when the change amount of the refraction index n2 of the clad 9 is small on the occasion.

In this regard, the case where the optical waveguide section 6 is a slab waveguide type and the case where the optical waveguide section 6 is a ridge waveguide type both share the same effect when the cross-sectional size of the core 8 is changed so that the response is changed based on the principle in the same manner. That is to say, at least one side of the cross-sectional surface perpendicular to the light propagation direction of the core 8 is formed by a straight line, and a large amount of response output can be obtained when the length of the one side is not more than 20 μm, and an even larger amount of response output can be obtained when the length of the one side is not more than 5 μm, in either of the cases where the optical waveguide section 6 is a slab waveguide type and where the optical waveguide section 6 is a ridge waveguide type. Further, as long as the refraction index difference Δn is a minus, a larger amount of response output and a faster response speed can be obtained, by reducing the cross-sectional surface of the core 8.

In this manner, the gas detection apparatus 1 can perform the detection of the detection gas by using the principle in which the refraction index of the sensitive resin changes depending on the existence and non-existence of the detection gas with a predetermined density.

As described above, in the gas detection apparatus 1 according to the present embodiment, unlike in the conventional sensors using the optical plastic fibers, the cross-sectional surface of the core 8 can be reduced. Further, as long as the refraction index difference Δn in an atmosphere of the detection gas with a density not less than the predetermined density is a minus, the response output can be obtained even when the change amount of the refraction index n2 of the clad 9 is small. Accordingly, a large amount of response output and a fast response speed can be obtained even with respect to a detection gas with low density in which the refraction index n2 of the clad 9 does not change greatly.

Further, by forming a rectangular shaped cross-sectional surface in which the length of at least one side thereof is not more than 20 μm, a larger amount of response output and a faster response speed can be obtained. Moreover, by making the above length be not more than 5 μm, an even larger amount of response output and an even faster response speed can be obtained.

Further, a large amount of response output can be obtained with respect to the detection gas with low density even when the change amount of the refraction index n2 of the clad 9 is small. Thus, a sensitive resin in which the change amount of reflex index is small, and a light receiving element with low performance, and the like, can hold up with being used, and the manufacturing costs and development costs thereof can be reduced.

Further, because the fast response speed can be obtained, a digital type sensor can be realized in which the response output is ON/OFF with respect to the existence and non-existence of the detection gas.

Further, the cross-sectional surface of the core 8 is formed to be in a minute scale such as a rectangular shaped cross-sectional surface of for example, 5 μm×5 μm, thus the core 8 can be connected to a single mode fiber without generating excessive connection loss. This is effective in designing a network.

Further, the apparatus is superior in mass production because the apparatus can be manufactured through a semiconductor process. In addition, the integration and the downsizing of the apparatus are easily performed because the optical waveguide section 6 can be formed in which the substrate 7 is formed from silicon.

### MODIFICATION EXAMPLE

Subsequently, a gas detection apparatus 1A is described as a modification example of the above explained embodiment. Incidentally, the configuration elements thereof which are similar to those in the above mentioned embodiment are allotted with the same reference numerals, and the description thereof will be omitted.

The gas detection apparatus 1A comprises an optical waveguide section 6A which is substituted for the optical waveguide 6.

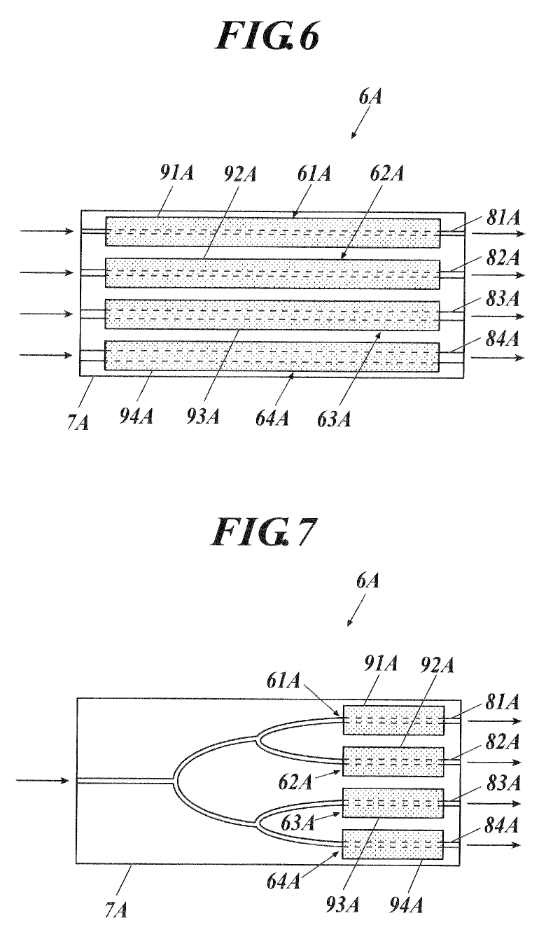

As shown in FIG. 6, the optical waveguide section 6A comprises four optical waveguides 61A-64A which have four sets of cores 81A-84A and clads 91A-94A on a substrate 7A.

The cores 81A-84A are formed to have cross-sectional surfaces perpendicular to the light propagation direction, each having a different size, and although they are not particularly limited, the cross-sectional surface of each of the cores is formed to be larger in degree from that of the core 81A to that placed in the lower direction of FIG. 6. Further, the cores 81A-84A are connected to the light source 2 and the light receiving element 3 through the light emitting side optical fiber 4a and the light receiving side fiber 4b (see FIG. 1) respectively at the left edge and the right edge of FIG. 6, so that the light propagates in the direction of the arrows shown in FIG. 6. In this regard, the connection of the cores 81A-84A and the light receiving element 3 is in a state where the light receiving element 3 can be switched to be connected to any one of the cores 81A-84A.

The clads 91A-94A are respectively formed on the cores 81A-84A, and are respectively formed from a sensitive resin in the same manner as in the above mentioned embodiment.

Incidentally, as shown in FIG. 7, the optical waveguide section 6A may be formed with an exposed region in which the cores 81A-84A are not covered with the clads 91A-94A in an upstream side in the light propagation direction of the clads 91A-94A. The optical waveguide section 6A may further be formed so that one core is branched into cores 81A-84A toward the downstream side of the light propagation direction in the exposed region. Moreover, the optical waveguide section 6A may be formed to have a core shape comprising a curved part in the exposed region.

Next, the operation of the gas detection apparatus 1A will be described.

In the gas detection apparatus 1A, the detection gas can be detected by the reaction of each of the sensitive resins which forms the clads 91A-94A with the detection gas having the density which is not less then the predetermined density, likewise the sensitive resin which forms the clad 9 in the above embodiment. In this regard, because the cores 81A-84A are formed to respectively have a cross-sectional surface with a different size, the four optical waveguides 61A-64A make the refraction index difference Δn be minus for the detection gas of respectively different predetermined densities. To put it more concretely, in the optical waveguide 61A comprising the core 81A having the smallest cross-sectional surface, the refraction index difference Δn is to be minus with respect to the detection gas with the lowest density, and the refraction index difference Δn is to be minus with respect to the detection gas with a higher density in degree from the optical waveguide 61A to the optical waveguide 64A comprising the core 84A having the largest cross-sectional surface.

Accordingly, by switching the cores 81A-84A which is to be connected to the light receiving element 3 through the light receiving side optical fiber 4b, the detection gas with different densities can be detected.

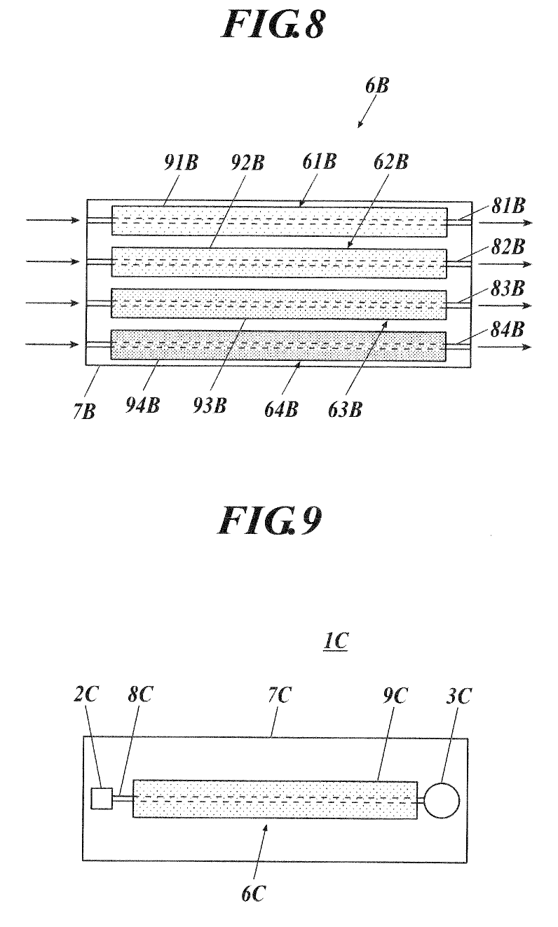

Further, the gas detection 1A apparatus may comprise an optical waveguide section 6B as shown in FIG. 8, substituted for the optical waveguide section 6A The optical waveguide section 6B comprises four optical waveguides 61B-64B which have four sets of cores 81B-84B and clads 91B-94B on the substrate 7B, in the same manner as the optical waveguide section 6A. In this regard, the cores 81B-84B are formed so as to have a cross-sectional surface of the same size. Further, the clads 91B-94B are respectively formed from a sensitive resin which is different in an initial refraction index and is equivalent in the change amount of the refraction index. In the gas detection apparatus 1A comprising the above described optical waveguide section 6B, the detection gas with different densities can be detected as well, by switching the cores 81B-84B which is to be connected to the light receiving element 3. Incidentally, the sensitive resin which forms the clads 91B-94B is not particularly limited as long as the refraction index thereof changes by the respective reaction with the detection gas of different densities. For example, the clads 91B-94B may respectively be formed from sensitive resins which have the same initial refraction index and differ in the change amount of the refraction index.

As described above, according to the gas detection apparatus 1A in the modification example of the present embodiment, besides the fact that the similar effect can be obtained as in the aforementioned embodiment, the detection of the detection gas with densities within a broad range becomes possible, because the optical waveguides 61A-64A comprising the cores 81A-84A and the clads 91A-94A respectively respond to detection gases with different densities.

### SECOND MODIFICATION EXAMPLE

Next, a gas detection apparatus 1C is described as a second modification example of the above explained embodiment incidentally, the configuration elements thereof which are similar to those in the above mentioned embodiment are allotted with the same reference numerals, and the description thereof will be omitted.

As shown in FIG. 9, the gas detection apparatus 1C comprises a light source 2C, a light receiving element 3C, and an optical waveguide section 6C. The optical waveguide section 6C is configured so as to be almost the same as the optical wave guide section 6 in the aforementioned embodiment, but differs in that the substrate 7C is formed so as to be slightly larger than the core 8C and the clad 9C. On the substrate 7C, the light source 2C and the light receiving element 3C are disposed other than the core 8C and clad 9C, and the light 2C and the light receiving element 3C are respectively connected to either of the ends of the core 8C.

According to the gas detection apparatus 1C described above, besides the fact that the similar effect can be obtained as in the aforementioned embodiment, the gas detection apparatus can be used as a downsized sensor device, because the light source 2C and the light receiving element 3C are integrated on the substrate 7C.

Incidentally, in the aforementioned modification example of the embodiment, the cores 81A-84A may riot be connected to the light receiving element 3 so that they can be switched to each other, but may be configured for example in a state where four different light receiving elements are provided for respective cores 81A-84A, so that the light receiving element which sensed the response output can be identified.

Further, the optical waveguides 61A-64A comprise the cores 81A-84A each having a cross-sectional surface with different sizes, and the clads 91A-94A formed from the same sensitive resin. However, the each of the clads 91A-94A may be formed from different sensitive resins.

Incidentally, the present invention is not limited to the aforementioned embodiment and the modification examples thereof, but can be modified without departing from the scope of the invention.

According to a preferred embodiment of the present invention, there is provided a gas detection apparatus comprising an optical waveguide, wherein

the optical waveguide comprises:
a core formed on a substrate, the core having a refraction index of n1; and
a clad to cover an upper part of the core, the clad having a refraction index of n2, wherein

at least one side of a cross-sectional surface of the core, perpendicular to a light propagation direction, is formed by a straight line, and wherein

the clad is formed from a sensitive resin which makes a magnitude relation of the refraction index of the core and the refraction index of the clad satisfy n1≦n2 in an atmosphere where a density of a detection gas is less than a predetermined density, and which makes the magnitude relation satisfy n1>n2 in an atmosphere where the density of the detection gas is not less than the predetermined density.

According to an embodiment of the present invention, there is provided a gas detection apparatus comprising an optical waveguide, wherein at least one side of a cross-sectional surface perpendicular to the light propagation direction of the core is formed by a straight line, and the clad is formed from a sensitive resin which makes a magnitude relation of the refraction index of the core and the refraction index of the clad satisfy n1≦n2 in an atmosphere where a density of a detection gas is less than a predetermined density, and which makes the magnitude relation satisfy n1>n2 in an atmosphere where the density of the detection gas is not less than the predetermined density. Thus, unlike the conventional sensor using the optical plastic fibers, the core diameter can be reduced. Furthers as long as there is the change amount so as to make the refraction index n2 of the sensitive resin satisfy n1>n2, the response output can be obtained even when the change amount is small. Accordingly, a large amount of response output and a fast response speed can be obtained even with respect to the detection gas with low density.

Preferably, the cross-sectional surface of the core is formed in a rectangular shape in which a length of the at least one side is not more than 20 μm.

According to an embodiment of the present invention, the cross-sectional surface of the core is formed in a rectangular shape in which the length of at least one side is not more than 20 μm. Thus, larger response output and faster response speed can be obtained.

Preferably, the length of the at least one side is not more than 5 μm.

According to an embodiment of the present invention, the length of at least one side is not more than 5 μm. Thus, even larger response output and even faster response speed can be obtained.

Preferably, the gas detection apparatus comprising the optical waveguide, further comprises a plurality of sets of the core and the clad, wherein

each cross-sectional surface of the plurality of cores has a different size from each other

According to an embodiment of the present invent on, the gas detection apparatus further comprises a plurality of sets of the core and the clad, wherein each cross-sectional surface of the plurality of cores has a different size from each other. Thus, each set comprising the core and the clad of the optical waveguide responds to a detection gas with a density which is different from each other. Accordingly, a detection of the detection gas with densities within a broad range becomes possible.

Preferably, the gas detection apparatus comprising the optical waveguide, further comprises a plurality of sets of the core and the clad, wherein

each of the plurality of clads is formed from the sensitive resin which changes each refraction index of each of the plurality of clads by a reaction with each of the plurality of detection gases having each of the plurality of predetermined densities, the plurality of predetermined densities being different from each other.

Accordingly to an embodiment of the present invention, the gas detection apparatus further comprises a plurality of sets of the core and the clad, wherein each of the plurality of clads is formed from a sensitive resin which changes each refraction index of each of the plurality of clads by a reaction with each of the plurality of detection gases having each of the plurality of predetermined densities, the plurality of predetermined densities being different from each other. Thus, each set comprising the core and the clad of the optical waveguide responds to a detection gas with a density which is different from each other. Accordingly, a detection of the detection gas with densities within a broad range becomes possible.

Preferably, at least one of the plurality of cores comprises:

an exposed region which is not covered with any one of the plurality of clads at an upstream side of the light propagation direction of the plurality of clads; and

a curved part or/and a branched part toward a downstream side of the light propagation direction, in the exposed region.

According to an embodiment of the present invention, at least one of the plurality of cores comprises: an exposed region which is not covered with any one of the plurality of clads at an upstream side of the light propagation direction of the plurality of clads; and a curved part or/and a branched part toward a downstream side of the light propagation direction, in the exposed region. Thus, a core which is formed in a curved shape or/arid a branched shape can be used. Accordingly, a shape design can be performed with a high degree of flexibility.

The entire disclosure of Japanese Patent Application No. 2008-100919 filed on Apr. 9, 2008 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A gas detection apparatus comprising an optical waveguide, wherein
the optical waveguide comprises:
a core formed on a substrate, the core having a refraction index of n1; and
a clad to cover an upper part of the core, the clad having a refraction index of n2, wherein
at least one side of a cross-sectional surface of the core, perpendicular to a light propagation direction, is formed by a straight line, and wherein
the clad is formed from a sensitive resin which makes a magnitude relation of the refraction index of the core and the refraction index of the clad satisfy n1≦n2 in an atmosphere where a density of a detection gas is less than a predetermined density, and which makes the magnitude relation satisfy n1>n2 in an atmosphere where the density of the detection gas is not less than the predetermined density.

2. The gas detection apparatus comprising the optical waveguide as claimed in claim 1, wherein the cross-sectional surface of the core is formed in a rectangular shape in which a length of the at least one side is not more than 20 μm.

3. The gas detection apparatus comprising the optical waveguide as claimed in claim 2, wherein the length of the at least one side is not more than 5 μm.

4. The gas detection apparatus comprising the optical waveguide as claimed in claim 1, further comprising a plurality of sets of the core and the clad, wherein
each cross-sectional surface of the plurality of cores has a different size from each other.

5. The gas detection apparatus comprising the optical waveguide as claimed in claim 1, further comprising a plurality of sets of the core and the clad, wherein
each of the plurality of clads is formed from the sensitive resin which changes each refraction index of each of the plurality of clads by a reaction with each of the plurality of detection gases having each of the plurality of predetermined densities, the plurality of predetermined densities being different from each other.

6. The gas detection apparatus comprising the optical waveguide as claimed in claim 4, wherein
at least one of the plurality of cores comprises:
an exposed region which is riot covered with any one of the plurality of clads at an upstream side of the light propagation direction of the plurality of clads; and
a curved part or/and a branched part toward a downstream side of the light propagation direction, in the exposed region.
